(19) United States
(12) Patent Application Publication
(10) Pub. No.: US 2014/0278597 A1
(43) Pub. Date: Sep. 18, 2014

(54) TRAVEL MANAGEMENT SYSTEM AND METHOD

(71) Applicant: Skydaddle, LLC, Raleigh, NC (US)

(72) Inventors: John Wilkinson, Raleigh, NC (US); Masood Fakharzadeh, Santa Clara, CA (US); Thomas Johansson, Redmond, WA (US); Sushma Bhope, San Jose, CA (US)

(21) Appl. No.: 13/838,724

(22) Filed: Mar. 15, 2013

(51) Int. Cl. G06Q 10/02

(52) U.S. Cl. CPC G06Q 10/02
USPC 705/5

(57) ABSTRACT

A system for managing corporate travel provides a search module in which a traveler may search travel options and receive travel approval in line with the travel policies of an organization. The traveler completes the booking outside the system, by any means, through any supplier or reseller. The completed booking is then reconciled within the system with credit card transaction information and/or expense report information with a reconciliation module.

### BACKGROUND OF THE INVENTION

1. Field of the Invention

The invention is in the field of corporate travel management, allowing a corporate traveler to search travel options (flight, hotel, car, rail, limo, etc.) using a search module, receive travel approval based on both policy and search results, complete the booking by any means through any supplier or reseller, and then reconcile stored travel searches with credit card transactions and/or expense reports within a policy reconciliation module. A travel management module permits an administrator to set and monitor corporate travel policies across an enterprise. The invention makes possible two traditionally exclusive objectives: travel governance for the company and purchasing freedom for the traveler.

2. Description of the Related Art

Historically, corporate travel management consisted almost exclusively of agent-assisted bookings. Transactions were conducted face-to-face, over the phone, and by fax. Larger businesses would dedicate fulltime staff or contract for dedicated travel agency staff. Corporate travel policies tended to be enforced by the agent, who would manually or with basic tools ensure that travel was booked with preferred suppliers, within spending limits, and consistently with other travel policies.

More recently, Travel Management Companies (TMCs) have allowed companies to more directly manage, monitor, and control corporate travel. TMCs typically provide a customized booking website configured with corporate travel policies. This booking website allows travelers to perform online transactions while constraining travelers to conform to policy. Meanwhile, the TMC also provides access to agents for offline transactions and access to account management to offer industry expertise and help guide companies on effective travel policies.

The TMC creates a website specifically designed for a corporate client to manage the corporate client's travel. The site contains the traveler profiles and associated travel policies as well as access to travel inventory, including publicly available options and special negotiated agreements with preferred suppliers. Typically, the TMC also provides an Agent Assistance Call Center that the traveler might call for more complicated trips or for en route assistance (for international and multi-segment trips, for example). In either case, the TMC, whether through an online tool or through an agent, guides the traveler to in-policy choices.

In the traditional corporate travel model, companies have sacrificed traveler flexibility and choice in exchange for governance. Specifically, in order to monitor traveler behavior, corporations require travelers to book through a single platform provided by the TMC. This single platform limitation deprives travelers of alternative suppliers, discounted fares, availability, perquisites, and other advantages.

For example, TMCs typically pull content from Global Distribution Systems (GDS) such as Sabre or Worldspan, which can provide only the products and fares made available to the GDS by the travel suppliers. GDSs do not have access to every airline, fare class, hotel, room inventory, seasonal discounts, etc. Airlines often make some fares available to the GDS but may also provide exclusive fares available only on their own website. These options that may be available to a leisure traveler are not available to the corporate traveler booking through the TMC.

As another example, suppliers often provide perquisites to travelers who book on their native website or call directly. These perquisites might include free upgrades, preferred seating, and loyalty points which are often not available to travelers booking through a TMC.

Travelers booking through a traditional TMC also cannot access bidding sites such as Priceline and Hotwire. This deeply discounted channel has been historically beyond the reach of business travelers booking through a TMC. Technologies such as “meta search” aggregators (such as Kayak.com) and itinerary aggregators (such as TripIt) are available to unmanaged travelers making low fares easier to find. These tools are usually not available to the traditional corporate travelers due to the single platform limitation.

As an example of a single-platform system, U.S. Pat. No. 5,832,451 describes a system of automatically managing travel service information which generates a business entity profile and individual profile for customers, and stores the information in a relational database. Travel information from a plurality of GDS sources is stored in the same database. Thus the business profile, the traveler's profile and information from the plurality of GDS sources is made available, simultaneously, for use by an agent in processing a customer's travel request. The system lacks traveler-facing shopping and booking tools. In addition, they system does not allow administrators to define policies and manage the travel program. Finally, the system does not provide credit card and expense reconciliation which provide a full view of the trip such as incidental hotel expenses which occur after the original reservation.

U.S. Pat. No. 8,140,361, for example, describes a system and method for integrating travel and expense management in which the traveler submits an expense report and the system reconciles the travel services data with expense report data. The system lacks the functionality whereby a user structures his or her travel within a corporate travel policy to obtain in-policy booking options and approval to book anywhere. Further, the system is focused on the matching algorithm between transactions and expenses, but it is limited by the same single platform limitation (referred to as the “client module”) that exists in the traditional TMC model.

Online travel agencies, such as Orbitz, Travelocity, and Expedia, offer significant travel choice to the user. U.S. Pat. No. 7,340,402, for example, describes an airline travel planning system in which a plurality of pricing solutions to a traveler's search query can be manipulated according to user specified preferences to produce a subset of pricing solutions. However, the online travel agencies offer no corporate governance. For example, there is no ability for travelers to identify the in-policy options and no ability for administrators to monitor traveler behavior. In addition, these online travel agencies are constrained by the same single platform limitation, in that travel suppliers may offer perquisites such as upgrades, enhanced seat availability, additional rooms, or loyalty points not available through the online travel agencies.

In view of the existing state of the art, an object of the invention is to provide a product suite which has the travel management capabilities of a conventional TMC site—one that identifies travel services for the user that are within the company's travel policy preferences—while at the same time affording travelers the flexibility of leisure travel booking sites and other leisure travel oriented technology.

A further object of the invention is to provide a system that identifies and stores in-policy and out-of-policy travel services selections made by a user, such that travel services may be purchased anywhere in any manner by the user, but such that the completed purchases may still be reconciled with corporate travel policy in a reconciliation module.

A further object of the invention is to provide travel managers with an interface that enables not only the setting of travel policies and the ability to approve or reject travel requests, but also provides a window onto the company's travel spend in the form of stored in-policy booking options made by travelers but not yet booked.

The present invention addresses the problems in the prior art with a system that allows companies to maintain governance without sacrificing traveler flexibility. This is achieved by providing an online shopping (rather than booking) website. The shopping website allows the user to search, review results, and (if required by policy) request approval for a trip. The user can then shop wherever and however he or she wants. Governance is maintained through “back-end” reconciliation with the credit card transaction and/or expense management report. This invention allows the best of both worlds.

### SUMMARY OF THE INVENTION

These and other objects of the invention are achieved, in one aspect, with a data processing system for managing purchases of travel services for an organization. The system comprises a server computer communicating with (1) a user interface running on a web site which permits a user to enter travel search criteria, view travel options, and receive approval to book travel; 2) a travel policy database storing a user's travel policies; 3) a search history database storing travel search criteria entered on the user interface and associated in-policy booking options; 4) a search module for identifying in-policy options from at least one travel services inventory based on a comparison of the user's travel search criteria and the user's travel policies; 5) a referral module which identifies vendors with whom travelers can complete the booking option; and 6) a credit card and/or expense report management reconciliation module which matches the stored searches with credit card transactions and expense reports. The server computer also communicates with an administrator interface running on the web site, which includes 7) a configuration module which allows an administrator to configure travel policies for all travelers using the system, and 8) a reporting module which allows administrators to view all searched, purchased, and expensed travel across an enterprise.

Collectively, these modules allow a company to govern and monitor travel while allowing travelers the freedom to leverage all possible booking methods and travel inventory. The invention does not attempt to block out-of-policy travel, because in any event, technology cannot effectively prohibit travelers determined to disregard travel policies. Rather, the system makes the rules clear and allows administrators to monitor traveler behavior through reports, emails, alerts and other means.

In another aspect, the invention is a method for managing purchases of travel services, comprising, with a server computer: configuring travel policies for travelers in an organization entered by an administrator in an administrator interface; storing the travel policies in a travel policy database; receiving a user's travel search criteria entered by a user in a user interface; searching a travel services inventory to identify an in-policy booking option based on the travel search criteria and the user's travel policy stored in the travel policy database; storing travel search criteria and in-policy booking options in a search history database; directing the user to a supplier external to the data processing system capable of completing the in-policy booking option; receiving completed purchase information from at least one of a credit card feed and an expense report feed; comparing completed purchase information with the in-policy booking option and travel search criteria with a reconciliation module and returning an expense report; viewing, in an administratormodule, in-policy booking options and stored travel search criteria of multiple users.

The system and method according to the invention enable companies to manage their corporate travel more cost effectively and efficiently. Unlike the traditional travel agency booking platform, the product suite of the invention is an online shopping platform rather than an online booking platform. Corporate travelers using the platform are shown a range of fares from a comprehensive set of travel suppliers that comply with their company's travel policy. The traveler is then referred to external sources to complete the booking. The traveler is not locked into a single-source or limited to a subset of the choices available to leisure consumers. The traveler retains his or her frequent traveler status and perks, something that is often lost through traditional corporate management. Meanwhile the administrator lowers travel costs and gains valuable and comprehensive reporting tools to monitor employee travel behavior.

### BRIEF DESCRIPTION OF THE DRAWINGS

FIG. 1, FIG. 2 and FIG. 3 together form a flow chart of a data processing system according to the invention.

FIG. 4 is a screen shot in an embodiment of the invention depicting a display of search results including in-policy booking option(s).

FIG. 5 is a screen shot in an embodiment of the invention involving socially networked group travel utilizing the system of the invention.

FIG. 6 depicts the modes in which the traveler interfaces with the system.

FIG. 7 depicts the modes in which the administrator interfaces with the system.

### DETAILED DESCRIPTION OF THE INVENTION

The following defined terms, where they are used in the disclosure, describe the different advantages provided by TMCs to corporate clients: “Governance” means that travelers are encouraged or required to purchase within travel policy; “Oversight” refers to company monitoring of traveler activity through reporting, email alerts, etc.; “Company Negotiated Agreements” means discounts negotiated with suppliers by leveraging travel volume. (Suppliers agree to these discounts in exchange for a greater market share of travel volume. The TMC will then load those agreements into the platform so that the company's travelers can leverage the negotiated discounts both online and through agents); “TMC Negotiated Agreements” refers to discounts negotiated by the TMC with suppliers which they make available to customers of the TMC and associated travelers. (Note that Company Negotiated Agreements are negotiated by a company leveraging the travel volume of the company made available only to employees of the company. By contrast, TMC Negotiated Agreements are negotiated by the TMC based on the cumulative travel volume across all of its corporate customers. Those discounts are then distributed to all of its corporate customers through the platform, both online through the booking website and offline through agents); “Account Management” refers to outside advice and expertise offered to the company to help manage travel programs. “Traveler Security” means the ability to locate a traveler in the event of a major travel event such as a hurricane or a terrorist attack.

Basic technology terms have the meaning attributed to them by those of ordinary skill in the art: “interface” refers to the means by which a user accesses the system of the invention. Typically, an interface is a graphical user interface (“GUI”) or series of GUIs on a computer, tablet, or smart phone screen, operated with a keyboard, mouse or touch screen. The TMC website according to the invention presents different interfaces to different users depending on whether the user enters traveler credentials or administrator credentials at login. These may be referred to as the “user interface” and the “administrator interface,” respectively. A “database” means indexed information stored on a computer readable medium. A “module” refers to a computer service or services running on one or more computers, and associated inputs and outputs, designed to perform a function or series of related functions.

A data processing system according to the invention is an integrated online product suite having a user interface running on a website which permits a user to enter search criteria, view travel options and receive approval to book travel using a search module. The user is sometimes referred to herein as the “traveler” to distinguish the “administrator” who is also a user of the system.

A traveler profile module operable through the user interface allows a user to store profile information such as name, address, and passport details; personal preferences such as aisle seats, non-smoking hotel rooms, cars with GPS devices, account numbers to vendor loyalty programs, etc. Collectively, this information can be passed to third party vendors as the vendor technology allows.

The administrator (also sometimes referred to herein as the “travel manager”) accesses the system through an administrator interface, having different administration rights than the traveler. FIG. 7 depicts the modes in which an administrator 710 accesses the system. An administrator may set a user's travel policy with tool 720. An administrator may access the administrator module and enter travel policy in the travel policy database with tool 730. The administrator module provides the ability of the administrator to access and view stored travel search criteria and in-policy booking options (and other information) across the entire organization using a reporting module 740. This functionality permits the administrator to estimate travel costs in advance and manage the company's travel spend and prepare reports. An administration configuration tool running on the website allows the administrator to configure travel policies for users or groups of users and store them in a traveler policy database. For example, the administrator may dictate that a traveler or group of travelers must book economy class for domestic flights, find fares within $100 of the lowest fares, and reserve hotel rooms under $200 in St. Louis, etc. The configuration tool may also allow an administrator to modify a user's traveler profile.

The search module includes a travel search tool which allows a user to enter travel search criteria and complete a search. Travel search criteria typically includes date and time of departure, departure and destination cities, hotel location and check-in date, etc. To access the search tool, the user logs in to a website and uses an interface that enables searches against one or more external travel inventories. The search module further includes a search comparison tool which pairs the search results generated by the travel search tool with the user's travel policy to identify an in-policy booking option. For example, the results paired with the travel policy may allow a user to purchase a flight (any flight) from San Francisco to Chicago up to $375. This results in an in-policy booking option of $375, as shown in FIG. 4. The search request plus the in-policy limits and approval are stored in a search history database indexed by a trip record and used for future reconciliation to ensure policy compliance. Available in-policy travel services, such as the specific flights depicted in FIG. 4, may also be identified for the traveler by the search module as described in greater detail below.

After approval is obtained, a referral tool within the data processing system may refer the traveler to third party suppliers of travel services. In addition to the approved amount for each requested travel service, flight, hotel and rental car (the in-policy option), the user may be presented with links to supplier sites where in-policy booking options may be purchased. The referral tool may display a series of logos and/or links to third party vendors who can provide the travel services. An active link to a third party vendor is not a required element of the data processing system according to the invention. For example, users can book by calling the airlines directly. However, the referral tool may provide opportunities for synergy between the third party vendors and the TMC operating the data processing system. For example, the system may log traveler clicks on the links displayed in the user interface, which may be used to obtain compensation from the referred partner. Participating suppliers may pay to have their company information displayed conspicuously compared to the other search results. No matter how the purchase is made, the purchase can be reconciled in the reconciliation module, which is described in greater detail below.

Thus, the system and method may also involve the administrator entering travel policies in an administrator module and searching and viewing in-policy and out-of-policy search results stored in the travel policy database across multiple users. Out-of-policy search results may be reconciled and expensed using reason codes entered by the traveler and approved automatically or manually by the administrator using the reconciliation module.

The credit card and expense management reconciliation module matches the in-policy booking options stored in the search history database with at least one credit card feed and/or expense report. In one embodiment, the traveler profile includes approved credit card information indicating that the traveler is approved to make purchases with that card and the purchases are completed with the approved card. The issuing credit card company provides a credit card feed to the reconciliation module. In a first step, the charges appearing on the feed are filtered according to information in the traveler profile. In a second step, the travel manager manually or automatically approves (“expenses”) a charge as being in-policy for a given travel event. Algorithms and techniques for reconciling credit card transactions for approval are known in the art and are not elaborated upon herein. Examples are described in U.S. Pat. Nos. 6,029,144 and 6,442,526, which are incorporated by reference in their entirety for this purpose. Alternatively, the user enters a completed purchase transaction by way of an expense report which is indexed to the trip record of the in-policy booking option stored in the search history database. Here, “reason codes” can be used to flag certain out-of-policy completed purchases to facilitate manual review and expensing of these transactions by the administrator.

By mapping credit card and expense reports to the information stored in the search history database, administrators can have full view of their travel program. In this way, administrators can immediately identify transactions that are out-of-policy. It is through this reconciliation tool that users are liberated to book through any vendor. Governance is achieved after-the-fact by matching the credit card and expense report.

The reporting tool includes user account management and corporate travel policy management enabling the travel manager to create travel policy for each user. The travel policy is used to highlight the travel options that are available to each user. By applying travel policies to travelers, corporations can control travel spending. The reporting tool includes a reconciliation module to compare employees' actual travel spending against expensed and researched travel. Using the travel reports, corporations can track travel and travel spending (i.e., who is traveling and for what purpose).

An exemplary system according to the invention is resolved into its component parts in FIGS. 1 to 3, wherein the dotted lines depict a flow of data through the system and solid lines depict logical or activity flow through the system components. The data processing system of the invention operates over a distributed computer network such as the Internet coordinated through the travel management website. The user interface may run on any device, including without limitation, a work station, personal computer, minicomputer, tablet, smartphone, or other device that is configured to enable a user to access the website and enter travel search criteria and communicate over the network. The user interface typically includes software that lets a user view Hypertext Markup Language documents and access files and software related to those documents. HTML-based systems, XML-based systems, Java™-based systems for this general purpose are known in the art and need not be elaborated upon herein.

As shown in the FIGS, the system includes user module (also referred to as traveler module) 10, search module 20, reporting module 30, referral module 40, and reconciliation module 50. The system components can be used to shop for different external services such as airline, bus, railroad, hotel and car reservations, and the like. For convenience, the elements of the invention are described in connection with booking, buying and reconciling a flight.

Referring to FIG. 6, a traveler 610 accesses the data processing system using a user interface. The first function of the user interface is to allow the traveler to update the individual user profile in the user profile database tool 620. The second function of the user interface is to allow for the traveler to complete searches for travel options in the search module tool 630. Upon completing a search in the search module, the traveler may click on links in the referral module to complete the booking process tool 640. After the booking process is completed, the traveler may match credit card transactions to inventory items with the reconciliation module tool 650. The traveler can create expense reports with unique trip record identifications in reconciliation module 660. Each of these modes is described in greater detail below.

Referring to the flowchart of FIG. 1, the user accesses the website at user sign-in tool 14 in the user interface and enters identifying information to initiate shopping. Additional identifying information may be entered from the user's travel profile stored in user profile database 12. The user's travel profile typically also includes authorized credit card information and details relating to the user's employment, such as job title and seniority, which are used at other stages of the system.

The user enters search criteria 22 using a tool in search module 20 which is accessed by the traveler in the user interface. Search criteria 22 generally includes at least date and time of travel, origin and destination, and may include other parameters that can be used to query a travel services inventory database to return search results 26, including but not limited to maximum number of connections, related service requirements (e.g., hotel, taxi, and car rental). Technologies for the user interface and search function are known in the art and are not elaborated upon herein. An example is described in U.S. Pat. No. 6,993,571, which is incorporated by reference.

Travel inventory search technology 24 accesses external databases (not shown), which may include a Global Distribution System (GDS), such as Apollo, Sabre, Galileo, Amadeus, and Worldspan, and may include direct connection to travel service supplier inventory, travel agency inventory or other third party search technology providers, such as QPX by ITA interfacing with GDS source(s) to provide access to travel services information. Travel inventory search technology 24 may also include database information including proprietary discounted rates from other sources. External databases can store the Airline Tariff Publishing Company database of published airline fares and their associated rules, routings and other provisions, the so-called ATPCO database. Travel inventory search technology 24 may contain an inventory of current availability of airline information for a particular carrier and so forth. The information from the external databases may be stored locally in the travel inventory search technology 24 and update periodically by accessing remote resources to maintain the database.

The search module 20 is implemented with a server computer having a computer memory or storage media storing a server process. The server process includes a search results process 26 that can produce from the entered search criteria sets of flights that can satisfy the query. The server process also includes a policy application process 28 which compares the search results 26 with the user's travel policies within travel policy database 29 to produce in-policy booking options. Travel policies relevant to travel management are also stored in the travel policy database 29. Travel policies include the company's preferences and policies with regard to how a travel search query may be resolved, which determines whether a search result is in-policy or out-of-policy. For example, a company may have: 1) a price tolerance above a lowest fare criteria; 2) specific supplier preference; and 3) limitations on what class flight can be booked for a given trip. Travel policies will differ depending on factors such as the traveler, the type of travel service, whether the service is domestic or international. A set of in-policy booking option(s) may be viewed in a display as shown in FIG. 4. An in-policy booking option 102 may simply iterate the company travel policy, but typically is accompanied by specific options 104, 106, and 108 available from specified suppliers.

“In-policy booking options” means saved policy approval criteria and options. Typically (but not necessarily) an in-policy booking option includes at least a maximum price for a searched travel service. In some scenarios, an in-policy booking option may be a service class, such as “any midsize rental car,” without a specific supplier or maximum price identified. Typically (but again not necessarily) in-policy booking option(s) includes one or more identified suppliers of travel services with whom travelers can complete the in-policy booking option. It should be noted that “in-policy booking option” may include results that violate a company's travel policies. Application of a user's travel policy in database 29 to search results 26 may result in zero available flights within the user's travel policy. Nevertheless, in this case, the “in-policy booking option” 102 (shown in FIG. 4) is the policy criteria “FLIGHT SHOULD NOT EXCEED $375.” Likewise, an administrator may set travel policy for a traveler such that all searched options are within policy. In this aspect, “in-policy booking option” has a broader definition than is typically given this term in the art. It is possible that all results may be out-of-policy. For example, there could be a policy where travelers are required to book 7 days in advance. If the traveler books fewer days in advance, then all results will be out of policy. Regardless, the saved search will store the policy settings and the best available out-of-policy options. The traveler may still complete the out-of-policy transaction which will be detected by the administrator during the reconciliation process. (Typically, companies handle this condition by allowing a user to set a “reason code” to identify the reasons for their out-of-policy transaction.) With the system of the present invention, an out-of-policy transaction may be purchased, entered in an expense report and manually approved by an administrator.

The in-policy booking option including stored travel search criteria is associated with a unique trip record 34 (depicted within reporting module 30). The trip record 34 is used by the traveler to complete expense reports, by the administrator to match completed purchase information with searched travel, as well as to view and manage travel program information across the enterprise. The trip record provides the identifying information in the reconciliation and reporting modules.

Referral module 40 is unique in the travel management industry because the user is directed to an external supplier to book travel services and is not constrained to purchase within the TMC platform. Inventory that is “internal” to the TMC means inventory and rates made available to or accessed by the TMC specifically. As noted above, the present invention does not rely on such inventory and rates. An “external” supplier or inventory means any other supplier or inventory. In some cases, the supplier is integrated through API or an embedded browser, but typically the user interface displays in-policy options with links to third party web sites where the in-policy options may be purchased. For a flight, the third party web site could be a dedicated airline services, or a well-known leisure travel booking agent. As will be apparent to those skilled in the art, the selection available will be much broader than those available in a single platform TMC model. A key difference between the system of the invention and both the known leisure travel booking models and the traditional single-platform TMC models is that the user is free to book anywhere, but his or her selection is confirmed as being in-policy because the stored in-policy search result is stored in search history database for later use by the system. Further, referral to third party purchase sites is an important potential source of revenue completely absent from the conventional travel management model. Referring to FIG. 4 for example, the referral module 40 displays in-policy booking options identified in the search module. Results and referral links display 44 can arrange and emphasize supplier information to increase traffic to one or another supplier by prior agreement. Display 44 may include live links to supplier websites. Clicks on those links may be logged as a potential source of revenue from the suppliers. Referral module 40 also creates a referral record 46, logging information from a credit card feed 52 and/or expense report feed 84, so that traveler purchases of travel services from suppliers identified in the search module 20 and displayed by the referral module 40 may be captured and monetized.

Subsequent interaction of the traveler 610 with the data processing system is further explained in the decision tree of FIG. 2. If the traveler does not like the in-policy booking options presented at 62 as the results of a search, the traveler can modify the search, entering new travel search criteria 22 and generating a new trip record 34. If the traveler likes the option(s), and the company's travel policy requires the additional step of obtaining approval, then manual approval may be obtained at 64. In either case, either automatic or manual approval having been obtained, the trip is approved at 68. In the typical case, a live link 74 is clicked by the traveler and a purchase is made at 76 using a credit card (which may be an approved credit card stored in the traveler's user profile). This information is provided to the referral technology 42 for the purposes of reporting and logging the success rate of the display of referral links, and to the reconciliation module for reconciling the expense. If more travel services are required/requested 78 the process is repeated, returning the traveler to in policy booking options. If the booking is made without using a link provided by the data processing system 72, the purchase information is nevertheless provided to the reconciliation module. Additional items to book 70, may likewise be made without using links provided by the data processing system. The traveler is returned to search results at 80, and the logical flow of the system proceeds in any case to the reconciliation module 50. If no further purchases are desired, the user's interaction with the system ends at 86.

Reconciliation module 50 in FIG. 3 reconciles a user's completed purchase to correspond with an in-policy booking option in the search history database 36. If the completed purchase can be reconciled with the in-policy booking option, the cost is approved or “expensed.” The reconciliation module includes both credit card reconciliation and expense report matching. Credit card reconciliation is further divided into two separate processes: credit card filtering and user assignment. Decision block 82 denotes that a purchase was made. If the purchase is made with a credit card, such as an approved credit card, credit card feed 52 is filtered for possible matches 54 in reconciliation module 50. Credit card filtering is achieved by comparing the itinerary item with a credit card feed and generating a list of potential matches. The matching is performed based on vendor name, purchase date, purchase amount, among other criteria. Credit card data feeds can contain different levels of detail with richer data feeds allowing the system to provide more precise matching. The user assignment process then allows the user to view the list of potential matches. He can select the exact match and assign it to the inventory item in the trip record. The credit card feed may be a feed from an account number authorized and stored in the travel policy database 29.

Alternatively, or in addition, information regarding the user's completed purchase including the trip identification may be provided in an expense report 84, which is entered through a user interface, provided as part of the product suite and stored in an expense report database 52. As in the previous example involving the credit card feed, the expense report is compared with in-policy search results stored in the search history database 29.

In some cases, known as “rogue travel,” a user will present completed purchases to be expensed without conducting a search at the user interface beforehand. Such purchases may have to be reconciled without the benefit of the reconciliation system of the invention and may be so labeled so that the travel manager and the users are incentivized over time to use the search module 20 to obtain approval in advance.

Thus the reconciliation process provides several opportunities for the user to interact with the data processing system before, during and after travel. The reconciliation module may also compare in-policy booking options stored in the search history database with a user's completed purchases to identify if travel services have been searched and approved but not yet booked. Reminders may be communicated to the user and/or the administrator after the passage of a predetermined period of time, or if the in-policy status of the search result changes. This functionality provides the administrator with a view of a company's travel spend “pipeline,” a feature not currently available through TMC or leisure travel platforms.

### EXAMPLE 1

An example of the method of the present invention is illustrated in connection with a hypothetical flight, car rental and hotel booking for a business trip. The specific example depicted in the FIGS is not to be deemed as limiting the invention. In the Example depicted, the user accesses the website and enters his or her name and login credentials in a user interface. The entered information is compared against the user's travel profile stored in the travel policy database. Once the user has been credentialed, the corporate travel policy pertaining to the user is loaded and the user conducts a search by entering travel search criteria, including departure time and date, origin city, destination city, return time and date, whether a car is needed, what type and where, whether a hotel is needed, what type and where, etc. This user query is compared to data typically available in a communications interface and temporary data storage medium existing between each of the available GDS systems and the system of the invention, but other sources to satisfy this query may be integrated.

The comparison yields a set of travel services, which are then compared with the user's individual travel policies stored in the travel policy database, including such information as what price above the lowest available fare the user is approved to pay. At this stage, the user is provided with an in-policy booking option. Further, the policy is set up so that the user does not require manual approval. The system tells the user that a) he or she is approved to pay a certain sum for a designated travel service; and optionally b) one or more suppliers where the purchase may be made.

Because the system operates at this stage as a search platform rather than a booking platform, the user has inventory available from many different suppliers rather than being limited to one GDS or booking platform like traditional TMC's. The traveler can compare choices across suppliers and make educated choices. This provides travelers and companies using the system with more choice than the traditional products on the market. As an example, traditional travel agencies have had a particularly difficult time adding train fares to their online offerings, because trains are sourced through a different channel than the traditional GDS and have different characteristics (fare classes, fare types, etc.) compared to airline reservations. With the present method, the user can search flights, obtain an approval for a fare amount, and then take a train. The purchase can still be reconciled with the use of an in-policy search result stored in the search history database, indexed to the same trip record.

In the present example, the user selects a flight, car and hotel, and is provided a link to an external website to complete the transaction. The user completes the transaction with a pre-authorized credit card stored in the travel profile database, taking advantage of the user's frequent flier upgrade, which is unrelated to any negotiated agreement between the company and the travel service provider. A credit card feed with completed purchase information is transmitted to the reconciliation module of the data processing system, compared with the in-policy search result stored in the search history database, and expensed. Reports are provided to the user and the travel manager.

### EXAMPLE 2

In this example, a user accesses the website, has his or her credentials verified, enters travel search criteria and receives confirmation of in-policy search results for each of a flight, hotel and car reservation stored in the search history database, all as in Example 1. However, the user in this Example changes plans due to a client meeting being moved to a different site than originally planned. He must change his flight and hotel, while deciding to keep the rental car for an extra day.

The user then searches the website again based on the new criteria, receives confirmation for in-policy searches, and completes the transactions offline. Later, when creating the expense report, the traveler uses the unique travel ID of the most recent search for credit card and expense reconciliation. The original search is still available, but not used for expense or credit card matching since its search criteria no longer apply to the trip.

### EXAMPLE 3

The invention permits the integration of social networking into a travel management system which has not been available in any TMC to date. This functionality is made possible because individual travelers may purchase anywhere, and because the system of the invention is adapted to provide a view of a travel program across an entire enterprise indexed by trip record. Referring to the screen shot 200 of FIG. 5, a group is associated on a given trip 202 with the group members appearing at block 206.

The invention provides that a trip may be associated to an account, contact or opportunity. Travelers can create groups with other travelers who have scheduled trips associated with same account, contact or opportunity at the same time. Administrators can grant travelers the ability to view reports detailing coworkers who will be in the same city on the same day as the traveler, appearing in data feed 208. This association allows administrators to review travel reports and make future travel decisions based on the customer details. For example, an administrator could see that his sales team has spent $10,000 in travel pursuing a $5,000 sales opportunity.

Images 204 or other information relating to specific travelers may accompany the display in the user interface. Travelers may then create a traveler group to collaborate on travel logistics and business strategy. For example, travelers may coordinate transportation or meal reservations within the group. Likewise, travelers can collaborate on meeting details such as creating an agenda or development of a presentation which will be delivered to the customer or contact. The collaboration can be completed by travelers visiting the online group and entering updates which can be viewed by other travelers visiting the same online group. The group could also be configured to relay posts to email, text messages, and other communication methods.

The above description of the preferred embodiments is not to be considered as limiting the invention. Variants of the embodiments described will inevitably occur to those of ordinary skill in the art and such variants are within the scope of the invention.

1. A data processing system for managing travel purchases for an organization, comprising:
a server computer communicating with
a user interface running on a website permitting a user to enter travel search criteria, view travel options, and receive approval to book travel;
a travel policy database storing a user's travel policies; and
a search module for identifying in-policy booking options from at least one travel services inventory based on the user's travel search criteria and the user's travel policies;
a search history database storing travel search criteria entered on the user interface and associated in-policy booking options;
a referral module for displaying at least one in-policy booking option;
a credit card and expense management reconciliation module which matches the stored travel search criteria and associated in-policy booking option with a credit card transaction and/or expense report;
a configuration module permitting an administrator to enter user travel policies across the organization, and
a reporting module permitting an administrator to view stored travel search criteria, associated in-policy booking options, and associated expense reports and credit card purchases for the organization.

2. The data processing system according to claim 1, comprising a user travel profile stored in a user profile database which can be modified from the user interface, and wherein the user travel profile includes at least approved credit card information.

3. The data processing system according to claim 2, wherein the user travel profile can be accessed and configured by an administrator from the configuration module.

4. The data processing system according to claim 2, wherein a credit card transaction feed matched in the reconciliation module is a feed from the approved credit card.

5. The data processing system according to claim 1, wherein the travel services inventory comprises at least one Global Distribution System and at least one of direct connection to travel services supplier inventory, third party search technology inventory, and travel agency inventory in addition to said Global Distribution System.

6. The data processing system according to claim 1, wherein the referral module provides at least one link to an external website.

7. The data processing system according to claim 6, wherein the completed purchase is a purchase completed on said external website.

8. The data processing system according to claim 1, wherein the user's travel policy comprises at least maximum cost per route information.

9. A data processing method for corporate travel management, comprising, with a server computer:
receiving travel policies for travelers in an organization entered in an administrator module;
storing the travel policies in a travel policy database;
receiving a user's travel search criteria entered in a user interface;
searching a travel services inventory to identify an in-policy booking option based on the travel search criteria and the user's travel policies;
storing entered travel search criteria and said in-policy booking option in a search history database;
referring the user to a supplier capable of completing the in-policy booking option;
completing a purchase of travel services with any external supplier;
receiving completed purchase information from at least one of a credit card feed and an expense report feed;
comparing completed purchase information with the in-policy booking option and approving the purchase in the administrator module.

10. The data processing method according to claim 9, wherein a completed purchase corresponding to an out-of-policy travel option is identified in an expense report and manually approved by an administrator.

11. The data processing method according to claim 9, wherein referring comprises displaying a link to said supplier.

12. The data processing method according to claim 11, wherein referring further comprises arranging supplier information in a display, logging clicks on said link, and logging credit card feed and expense report feed in a referral record.

13. The data processing method according to claim 9, wherein the completed purchase is made other than by clicking on the link to said supplier.

14. The data processing method according to claim 9, comprising preparing a report containing information from multiple users or multiple transactions across an organization in an administrator module.

15. The data processing method according to claim 9, wherein the step of receiving the user's travel search criteria includes receiving login information from the user including at least information identifying an approved credit card used to make completed purchases.

16. The data processing method according to claim 15, wherein the credit card feed is a feed from the approved credit card used to make a completed purchase.

17. The data processing method according to claim 10, wherein the step of searching a travel services inventory comprises searching at least one global distribution system and at least one other source.

18. The data processing method according to claim 9, wherein said supplier inventory is accessed through API or an embedded browser.

19. The data processing method according to claim 9, wherein expense report information and credit card feed information is associated with a trip identification stored with said in-policy booking option in said search history database.

20. The data processing method according to claim 9, further comprising comparing an in-policy booking option stored in the search history database with a user's completed purchases to identify an in-policy booking option that has not resulted in a completed purchase and communicating this information to the user and/or the administrator.
